(19) United States
(12) Patent Application Publication
(10) Pub. No.: US 2026/0313024 A1
(43) Pub. Date: Oct. 8, 2026

(54) Operating Scheme for Power Tool Wireless Mesh Network

(71) Applicant: Milwaukee Electric Tool Corporation, Brookfield, WI (US)

(72) Inventors: Zoltan Polik, Wauwatosa, WI (US); Anthony M. Davis, Brookfield, WI (US); Timothy R. Obermann, Waukesha, WI (US); Jonathan E. Abbott, Milwaukee, WI (US)

(21) Appl. No.: 19/100,851

(22) PCT Filed: Aug. 21, 2023
(86) PCT No.: PCT/US2023/072571

§ 371 Date: Feb. 3, 2025

Related U.S. Application Data
(60) Provisional application No. 63/401,027, filed on Aug. 25, 2022.

(51) Int. Cl. H04L 67/12; B25F 5/00; H02J 7/40; H02J 7/82

(52) U.S. Cl. CPC H04L 67/12; B25F 5/00; H02J 7/40; H02J 7/82

(57) ABSTRACT

A power tool, a power tool system, and a method for wireless power tool networking involve distributed intelligence running on individual nodes in a wireless mesh network. A node can determine a first operating parameter associated with a power tool, determine a second operating parameter associated with a mesh network, identify a node type of the power tool based on at least one of the first operating parameter or the second operating parameter, and operate the power tool as a node in the mesh network in accordance with the node type.

### RELATED APPLICATIONS

The present application is based on and claims priority from U.S. Patent Application No. 63/401,027, filed on Aug. 25, 2022, the entire disclosure of which is incorporated herein by reference.

### BACKGROUND

Power tools can be used for a variety of purposes such as cutting, drilling, driving, sanding, shaping, grinding, polishing, painting, heating, lighting, cleaning, gardening, and construction, among other uses. More recently, wireless communication capabilities have been incorporated into power tools to enable the power tools to communicate with other power tools and wireless devices.

### SUMMARY

Power sources for power tools are often limited in capacity, such as batteries that require frequent charging and/or replacement. Accordingly, when connecting power tools to a wireless network, efficiency in terms of power consumption, data bandwidth, and connection structure, for example, is generally desired.

Some embodiments of the disclosure provide a power tool. The power tool can include a power source, an antenna for wireless communication, and a controller in communication with the antenna and including a processor and a memory. The processor can be configured to execute instructions stored in the memory such that the controller is configured to establish a wireless connection as a node in a mesh network using the antenna, determine a first operating parameter associated with the power tool, determine a second operating parameter associated with the mesh network, identify a node type of the power tool based on at least one of the first operating parameter or the second operating parameter, and operate the power tool as the node in the mesh network in accordance with the node type.

Some embodiments of the disclosure provide method for wireless power tool networking. The method can include establishing, by a power tool, a wireless connection as a node in a mesh network, determining, by the power tool, a first operating parameter associated with the power tool, determining, by the power tool, a second operating parameter associated with the mesh network, identifying, by the power tool, a node type of the power tool based on at least one of the first operating parameter or the second operating parameter, and operating, by the power tool, as the node in the mesh network in accordance with the node type.

Some embodiments of the disclosure provide a power tool system. The system can include a first power tool wirelessly connected as a first node in a mesh network and a second power tool wirelessly connected as a second node in the mesh network. The second power tool can include circuitry configured to determine a first operating parameter associated with the first power tool, determine a second operating parameter associated with the second power tool, identify a node type of the second power tool based on at least one of the first operating parameter or the second operating parameter, and operate the second power tool as the second node in the mesh network in accordance with the node type.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is an illustration of different components in an example wireless power tool system.

FIG. 2 is a block diagram illustrating different components of an example power tool that can be used in the system of FIG. 1.

FIG. 3 is a block diagram illustrating different components of an example wireless communication device that can be used in the system of FIG. 1.

FIG. 4 is an illustration of different components of a first example power tool wireless mesh network configuration.

FIG. 5 is an illustration of different components of a second example power tool wireless mesh network configuration.

FIG. 6 is an illustration of different components of a third example power tool wireless mesh network configuration

FIG. 7 is an example graph illustrating node type transition functionality in a power tool wireless mesh network.

FIG. 8 an example state diagram illustrating node type transition functionality in a power tool wireless mesh network.

FIG. 9 is another example state diagram illustrating node type transition functionality in a power tool wireless mesh network.

FIG. 10 is a flowchart illustrating aspects of an operation scheme for a power tool wireless mesh network.

### DETAILED DESCRIPTION

An operation scheme for a power tool wireless mesh network involves distributed intelligence running on individual nodes in the mesh network for determining appropriate node types during live operation of the mesh network. The nodes can determine appropriate node types based on operating parameters associated with the node itself and/or operating parameters associated with the mesh network more generally. This dynamic node type transition functionality can provide improved efficiency in terms of power consumption, data bandwidth, communication data rate, maximum number of connected nodes, maximum reachable distance, connection structure, and other aspects of mesh network operation for power tool applications. Examples of operating parameters relevant to node type transitions include battery status, node types of neighboring nodes in the mesh network, and distances between neighboring nodes in the mesh network. Other approaches for selecting wireless mesh network node types include static selection where node types do not change during live operation, pre-defined selection where node types are defined at the design phase of system development, manual selection where node types are manually selected by users, and externally controlled where node types are changed by an external controller that does not operate as a node in the mesh network. In some common mesh networking applications, individual nodes have a wired connection to a grid-powered outlet and, accordingly, are not particularly sensitive to power consumption or power efficiency. However, power tool applications involving limited capacity batteries can be highly sensitive to power consumption. Additionally, in some mesh networking applications (e.g., agricultural sensors, parking lot sensors, or presence detectors), the node types are static for nodes in a network because, for example, the consistent desire for low power consumption and generally static environment in which the nodes are placed. However, in power tool applications, the environment can be dynamic, for example, with power tool operational modes, power status, and location potentially changing frequently.

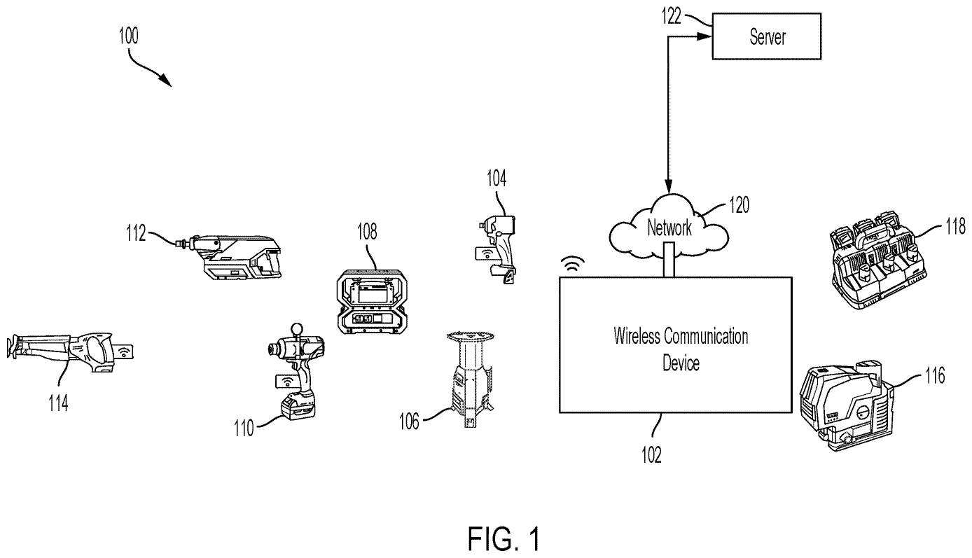

FIG. 1 illustrates an example wireless power tool system 100. Power tool system 100 includes a wireless communication device 102 and a collection of power tools including a power tool 104, a power tool 106, a power tool 108, a power tool 110, a power tool 112, a power tool 114, a power tool 116, and a power tool 118. In power tool system 100, a wireless communication device 102 and power tools 104, 106, 108, 110, 112, 114, 116, and 118 are connected to a wireless network 120 and a server 122. Wireless communication device 102 can be configured to communicate directly and indirectly with each of power tools 104, 106, 108, 110, 112, 114, 116, and 118. For example, wireless communication device 102 can be configured to control various operating parameters associated with each of power tools 104, 106, 108, 110, 112, 114, 116, and 118. Wireless communication device 102 can also be used to view, via a user interface presented on wireless communication device 102, a variety of different data and information about each of power tools 104, 106, 108, 110, 112, 114, 116, and 118. Wireless communication device 102 can also be used to configure settings for wireless network 120, such as adding or removing power tools from wireless network 120.

Wireless communication device 102 can be implemented in a variety of different ways. For example, wireless communication device 102 can include components such as a processor, memory, a display, inputs (e.g., a keyboard, a mouse, a graphical user interface, a touch-screen display, one or more actuatable buttons, etc.), communication devices (e.g., an antenna and appropriate corresponding circuitry), etc. Wireless communication device 102 can also simply be implemented as a processor. Wireless communication device 102 can be implemented as a mobile phone (e.g., a smart phone), a personal digital assistant (“PDA”), a laptop, a notebook, a netbook computer, a tablet computing device, and other similar types of wireless electronic devices. Wireless communication device 102 can include a power source (e.g., an AC power source, a DC power source, etc.), which can be in electrical communication with one or more power outlets (e.g., AC or DC outlets) and/or one or more charging ports (e.g., for charging a battery pack of a power tool). Thus, in some cases, wireless communication device 102 can be a portable power supply and/or a charging device for one or more of power tools 104, 106, 108, 110, 112, 114, 116, and 118. Wireless communication device 102 can also be implemented as a cellular tower, a Wi-Fi router, a network switch, and other types of networking devices. In this way, some (or all) of power tools 104, 106, 108, 110, 112, 114, 116, and 118 can be configured to communicate with wireless communication device 102 implemented as a cell tower (e.g., a power tool can have antennas, transmitters, transceivers, cellular modules, etc., that facilitate communication with the cellular tower so that a power tool can communicate therewith), and thus power tools that are not able to directly communicate (e.g., lack the electronic circuitry including an antenna, a transmitter, a transceiver, etc.) with the wireless communication device 102 (e.g., implemented as a cellular tower) can still indirectly communicate, via wireless network 120, via other power tools that are configured to communicate directly with the wireless communication device 102. Regardless of the configuration of wireless network 120, wireless communication device 102 can receive an identifier for each of power tools 104, 106, 108, 110, 112, 114, 116, and 118.

Each of power tools 104, 106, 108, 110, 112, 114, 116, and 118 can include an actuator, a power source (e.g., a battery pack), an electronic controller, a power source interface (e.g., a battery pack interface), and/or other similar components. Power tools 104, 106, 108, 110, 112, 114, 116, and 118 can be different kinds of power tools, or they can all be the same types of power tools. For example, one or more of power tools 104, 106, 108, 110, 112, 114, 116, and 118 can be an impact driver, a power drill, a hammer drill, a pipe cutter, a sander, a nailer, a grease gun, a crimper, a battery charger, laser level, jobsite lighting/work light, jobsite ruggedized radio, or any other suitable tool. Power tools 104, 106, 108, 110, 112, 114, 116, and 118 can be used for various purposed such as cutting, drilling, driving, sanding, shaping, grinding, polishing, painting, heating, lighting, cleaning, gardening, charging, and construction, among other uses. Each of power tools 104, 106, 108, 110, 112, 114, 116, and 118 can be configured to directly communicate with each other (e.g., over a wireless communication channel), and each of power tools 104, 106, 108, 110, 112, 114, 116, and 118 can be configured to communicate directly with wireless communication device 102. In some configurations, each of power tools 104, 106, 108, 110, 112, 114, 116, and 118 can directly communicate with each other according to a wireless protocol, which can be a Bluetooth® wireless protocol. Similarly, each of power tools 104, 106, 108, 110, 112, 114, 116, and 118 can be configured to directly communicate with wireless communication device 102 according to a wireless communication protocol, which can be a Bluetooth® wireless protocol.

Power tools 104, 106, 108, 110, 112, 114, 116, and 118 can be configured in a wireless mesh network, such as a wireless Bluetooth® Low Energy (BLE) mesh network, where power tools 104, 106, 108, 110, 112, 114, 116, and 118 operate as individual nodes in the mesh network that are connected to each other directly, dynamically, and non-hierarchically such that the individual nodes cooperate with each other to efficiently route data throughout the mesh network. Each of power tools 104, 106, 108, 110, 112, 114, 116, and 118 can include a tool identifier associated therewith that uniquely identifies the respective power tool from other power tools. For example, the tool identifier can be a media access control (“MAC”) address, among other types of device identifiers used in a mesh network.

Mesh networks of power tools can operate simultaneously with one or more separate networks. For example, a BLE mesh network of power tools can operate simultaneously with standard Bluetooth advertisements. The simultaneous operation can be realized with a time division scheme, for example, where a mesh network can be run for a first time period (e.g., a few hundred milliseconds) and a non-mesh network can be run for a second time period (e.g., another few hundred milliseconds). A variety of different types of time division schemes can be used depending on the intended application. Moreover, power tools with larger batteries and/or wired power connections can be strategically located within a mesh network, such as closer to the center of the mesh network to function more effectively as friend nodes and/or relay nodes.

Power tools 104, 106, 108, 110, 112, 114, 116, and 118 can each include one or more antennas (e.g., as part of one or more Bluetooth® wireless modules) that are capable of communicating with other devices (e.g., other power tools) according to a Bluetooth ® wireless protocol, which can have advantages as compared to other wireless protocols (e.g., using less power to communicate, providing fast communication speeds, ensuring one-to-one pairing between devices at some times, etc.). The direct communication range between wireless communication device 102 and a respective power tool 104, 106, 108, 110, 112, 114, 116, or 118 can be fairly short (e.g., 25 or 30 feet), but by using a mesh network, the indirect communication range can be increased considerably as compared to the direct communication range.

Generally, wireless communication device 102 can communicate with server 122 via wireless network 120. More particularly, wireless communication device 102 can communicate with an access point of wireless network 120 to communicate with the server 122 over wireless network 120. The access point can include, for example, a cellular tower or a Wi-Fi router. Additionally, wireless communication device 102 can serve as a gateway device to enable a power tool to communicate with the server 122 via wireless network 140. Server 122 can store data associated with power tools 104, 106, 108, 110, 112, 114, 116, and 118 including configuration data (e.g., operating parameters, current status, network identifiers, etc.), usage data (e.g., number of hours of available operation, number of hours in use, etc.), maintenance data (e.g., maintenance history, suggestions for future maintenance, etc.), operator and ownership data, work site data, location data (e.g., for inventory management and tracking), among other types of data. This data can be viewed from wireless communication device 102 in some examples. Server 122 van be implemented in a variety of manners, such as an on-premises server or servers, a remote (cloud) server or servers, or a combination of both (hybrid). In some implementations, wireless network 120 is the Internet. In some implementations, server 122 can perform node type determination and transition functionality such as discussed herein based on data received from server 122 by nodes in a mesh network.

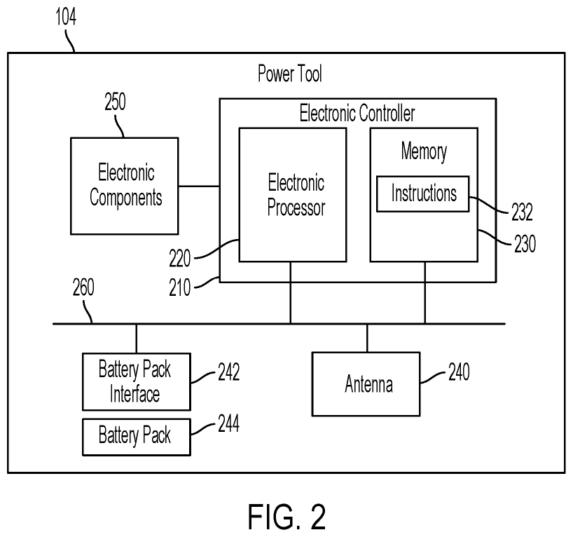

FIG. 2 shows a block diagram illustrating different components of an example implementation of power tool 104. As shown, the example implementation of power tool 104 includes an electronic controller 210, which includes an electronic processor 220 and memory 230. Power tool 104 as shown also includes an antenna 240, a battery pack interface 242, a battery pack 244, a set of electronic components 250, and a communication bus 260. Memory 230 stores instructions 232 that can be executed by electronic processor 220 such that electronic processor 230 implements operations for power tool 104 in accordance with instructions 232. The operations implemented by electronic processor 220 can include sending and receiving data via communication bus 260 and antenna 240, for example. Power tool 104 can include additional components for communication and other functionality beyond these components illustrated in FIG. 2.

Memory 230 can be implemented using any suitable type or types of memory, including read-only memory (ROM), random access memory (RAM), volatile memory, non-volatile, other non-transitory computer-readable media, and/or various combinations thereof. Data stored in memory 230, including instructions 232, can be generated by wireless device 102, server 122, or any of the other power tools 106, 108, 110, 112, 114, 116, and 118 connected to network 120, among other devices. Some of the data stored in memory 230 can be loaded onto power tool 104 at the time of manufacturing, and other data can be stored in memory 230 during the operational lifetime of power tool 104. Electronic processor 220 can be implemented using a variety of different types and/or combinations of processing components and circuitry, including various types of microprocessors, central processing units (CPUs), and the like. For example, the electronic processor 220 may include one or more processors (co-located or distributed) cooperating to perform the functions of the electronic processor 220 described herein.

Antenna 240 can be communicatively coupled to electronic controller 210. Antenna 240 can enable electronic controller 210 (and, thus, the power tool 104) to communicate with other devices, such as with wireless communication device 102, server 122, and the other power tools 106, 108, 110, 112, 114, 116, and 118 connected to network 120. Antenna 240 can facilitate a communication via Bluetooth® (e.g., in a mesh network), Wi-Fi, and other types of communications protocols. In some examples, antenna 240 can further include a global navigation satellite system (GNSS) receiver of global positioning system (GPS) receives configured to receive signals from satellites, land-based transmitters, and the like.

Battery pack interface 242 can be configured to selectively receive and interface with battery pack 244 such that battery pack 244 serves as a power source for power tool 104. Battery interface 242 can include one or more power terminals and, in some cases, one or more communication terminals that interface with respective power terminals, communication terminals, etc., of battery pack 244. Battery pack 244 can include one or more battery cells of various chemistries, such as lithium-ion (Li-Ion), nickel cadmium (Ni-Cad), etc. Battery pack 244 can further selectively latch and unlatch (e.g., with a spring-biased latching mechanism) to the power tool 104 to prevent unintentional detachment. Battery pack 244 can further include a pack electronic controller (pack controller) including a processor and a memory. The pack controller can be configured similarly to electronic controller 210. The pack controller can be configured to regulate charging and discharging of the battery cells, and/or to communicate with the electronic controller 210. Battery pack 244 can further include an antenna, like antenna 240, coupled to the pack controller via a bus like bus 260. Accordingly, battery pack 244 can be configured to communicate with other devices, such as wireless communication device 102 or the other power tools 106, 108, 110, 112, 114, 116, and 118. Battery pack 244 can communicate battery status information (e.g., percent charged, charging rate, charger connection status, etc.) to electronic controller 210 via battery pack interface 242.

Battery pack 244 can be coupled to and configured to power the various components of the power tool 104, such electronic controller 210, the antenna 240, and electronic components 250. However, to simplify the illustration, power line connections between the pack 244 and these components are not illustrated. While the example illustration in FIG. 2 shows power tool 104 being powered by battery pack 244, it is important to note that different types of power sources can be used to power tool 104, and the other power tools 106, 108, 110, 112, 114, 116, and 118 in network 120. For example, power tool 104 could be powered by a wired connection to a power outlet, or other sources of power.

Electronic components 250 can be implemented in a variety of different ways and can include a variety of different components depending on the type of power tool. For example, for a motorized power tool (e.g., drill-driver, saw, etc.), electronic components 250 can include, for example, an inverter bridge, a motor (e.g., brushed or brushless) for driving a tool implement, and the like. For a non-motorized power tool (e.g., a work light, a work radio, ruggedized tracking device, a laser level, a laser distance measurer, battery pack chargers, portable power supplies etc.), electronic components 250 can include, for example, one or more of a lighting element (e.g., an LED, a laser, etc.), an audio element (e.g., a speaker), a sensor (e.g., a light sensor, ultrasound sensor, etc.), charging circuitry, power conversion circuitry, and the like. In some examples, the antenna 240 can be located within a separate housing along with electronic controller 210 and/or a second electronic controller, where the separate housing selectively attaches to power tool 104. For example, the separate housing can attach to an outside surface of the power tool 104 or can be inserted into a receptacle of power tool 104. Accordingly, the wireless communication capabilities of the power tool 104 can reside in part on a selectively attachable communication device, rather than integrated into a housing of power tool 104 itself. Such selectively attachable communication devices can include electrical terminals that engage with reciprocal electrical terminals of power tool 104 to enable communication between the respective devices and enable power tool 104 to provide power to the selectively attachable communication device. Electronic components 250 can also include different types of sensors, among other suitable components.

Although described with respect to the power tool 104, the diagram of FIG. 2 can also apply to one or more of the other power tools 106, 108, 110, 112, 114, 116, and/or 118 of power tool system 100. The diagram of FIG. 2 can also apply to certain implementations of battery pack 244, except that, in a power tool battery pack implementation, battery pack interface 242 and battery pack 244 of the diagram are replaced with a tool interface (to interface with a battery pack interface of a power tool). In the case of the power tool battery pack implementation, electronic components 250 can include, for example, one or more battery cells, a charge level fuel gauge, analog front ends, different types of sensors, and the like.

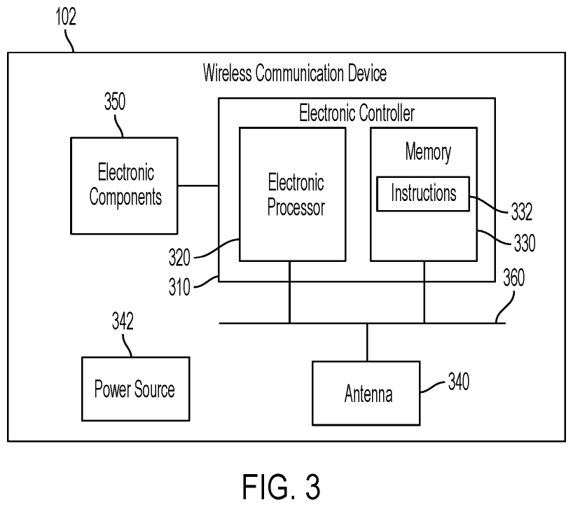

FIG. 3 shows a block diagram illustrating different components of an example implementation of wireless communication device 102. As shown, the example implementation of wireless communication device 102 includes an electronic controller 310, an antenna 340, a power source 342, a set of electronic components 350, and a communication bus 360. Electronic controller 310 is shown to include an electronic processor 320 and a memory 330, which stores instructions 332 that can be executed by electronic processor 320 such that electronic processor 320 implements operations for wireless communication device 102 in accordance with instructions 332. The operations implemented by electronic processor 320 can include sending and receiving data via antenna 340, for example.

Memory 330 can be implemented using any suitable type or types of memory, including read-only memory (ROM), random access memory (RAM), volatile memory, non-volatile, other non-transitory computer-readable media, and/or various combinations thereof. Data stored in memory 330, including instructions 332, can be generated by wireless device 102, server 122, or any of the power tools 104, 106, 108, 110, 112, 114, 116, and 118 connected to network 120, among other devices. Some of the data stored in memory 330 can be loaded onto wireless communication device 102 at the time of manufacturing, and other data can be stored in memory 330 during the operational lifetime of power tool 104. Electronic processor 320 can be implemented using a variety of different types and/or combinations of processing components and circuity, including various types of microprocessors, central processing units (CPUs), graphics processing units (GPUs), and the like. For example, the electronic processor 320 may include one or more processors (co-located or distributed) cooperating to perform the functions of the electronic processor 320 described herein.

Antenna 340 can be implemented using one or more antennas, and can be communicatively coupled to electronic controller 310, for example through communication bus 360. Antenna 340 can enable wireless communication device 102 to communicate with server 122 and the power tools 104, 106, 108, 110, 112, 114, 116, and 118 connected to network 120, among other devices. Power source 342 can be implemented in a variety of ways depending on the type of device (or devices) used to implement wireless communication device 102. For example, power source 342 can be implemented using one or more batteries and/or a wired connection to one or more power outlets.

Electronic components 350 can be implemented in a variety of ways depending on the type of device used to implement wireless communication device 102. For example, in implementations where wireless device 102 is a smartphone, electronic components 350 can include a touch screen display, speakers, push buttons, a charging port, and the like. Electronic components 350 can also include different circuitry such as for lighting, processing, communication (e.g., different types of communication modules including both in hardware and software), charging, and other functionality. Electronic components 350 can also include input devices such as a keypad, a touch screen, a keyboard, a mouse, and the like.

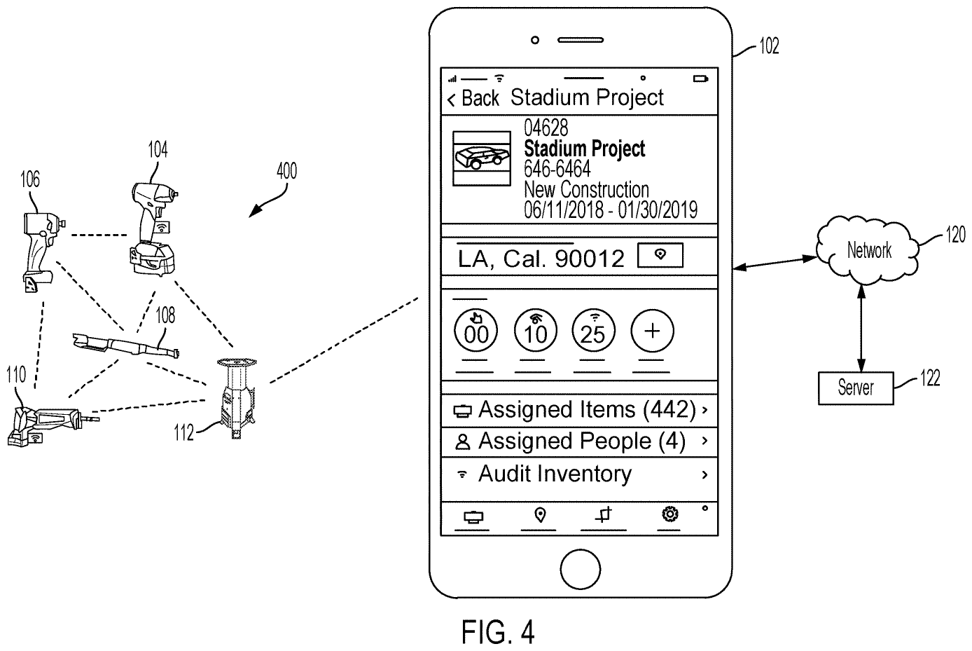

FIG. 4 shows an illustration of different components of an example power tool wireless mesh network 400. Mesh network 400 represents a possible implementation of power tool system 100 as discussed above. Mesh network 400 includes power tools 104, 106, 108, 110, and 112 each connected as individual nodes in mesh network 400 and each implemented as motor-driven power tools. Also, mesh network 400 includes an implementation of wireless communication device 102 as a smartphone that runs a mobile application and/or a web browser to communicate with and manage data associated with power tools 104, 106, 108, 110, and 112 in mesh network 400. Each of the nodes in mesh network 400 can execute logic according to process 1000 discussed in more detail below to dynamically determine an appropriate node type for operating within mesh network 400 for improved operational efficiency.

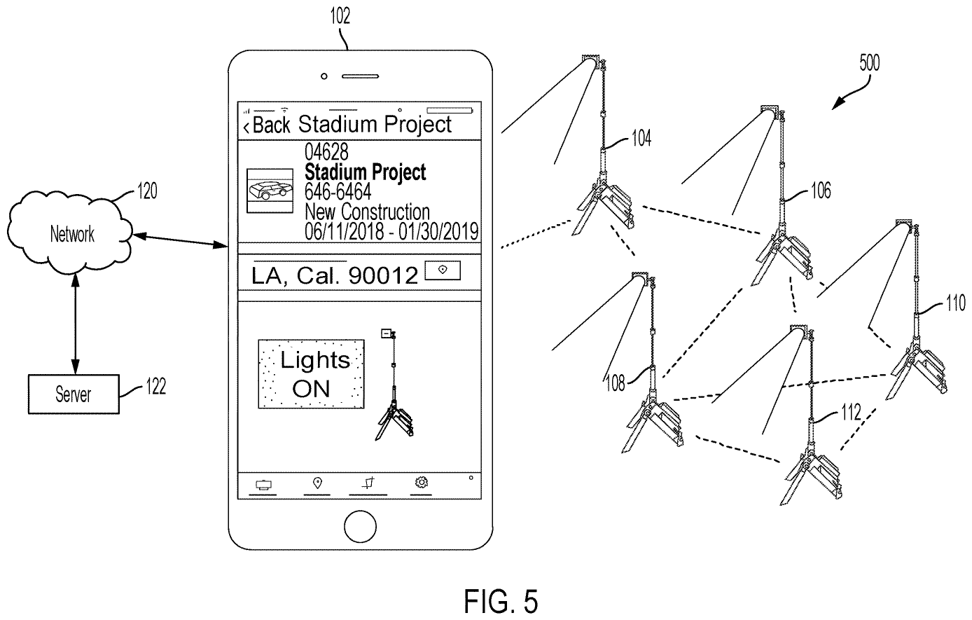

FIG. 5 shows an illustration of different components of an example power tool wireless mesh network 500. Mesh network 500 represents another possible implementation of power tool system 100 as discussed above. Mesh network 500 includes power tools 104, 106, 108, 110, and 112 each connected as individual nodes in mesh network 500 and each implemented as power lights for use at a work site. Mesh network 500 also includes an implementation of wireless communication device 102 as a smartphone that runs a mobile application and/or a web browser to communicate with and manage data associated with power tools 104, 106, 108, 110, and 112 in mesh network 500. Each of the nodes in mesh network 500 can execute logic according to process 1000 discussed in more detail below to dynamically determine an appropriate node type for operating within mesh network 500 for improved operational efficiency.

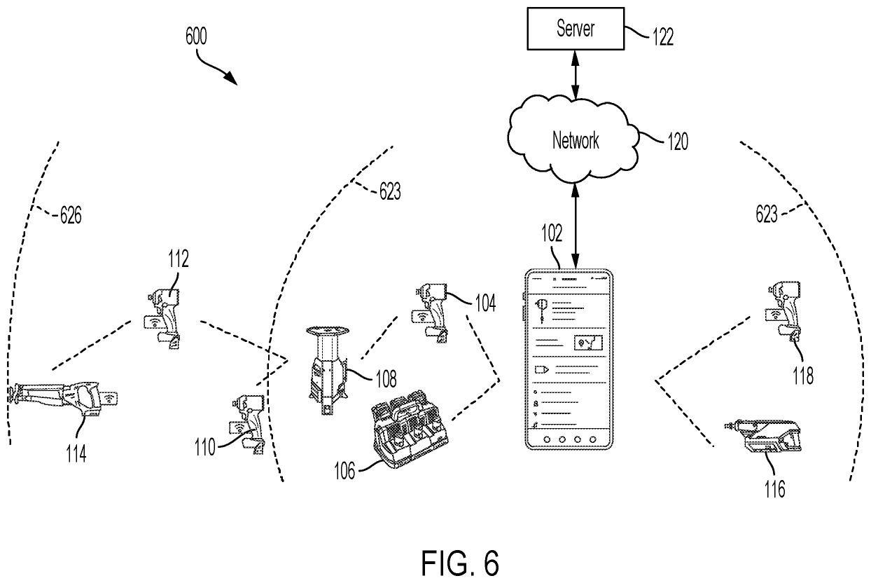

FIG. 6 illustrates different components of an example power tool wireless mesh network 600. Mesh network 600 represents yet another possible implementation of power tool system 100 as discussed above. Mesh network 600 includes power tools 104, 106, 108, 110, 112, 114, 116, and 118 each connected as individual nodes in mesh network 600 and each implemented as motor-driven power tools. Also, mesh network 600 includes an implementation of wireless communication device 102 as a smartphone that runs a mobile application and/or a web browser to communicate with and manage data associated with power tools 104, 106, 108, 110, 112, 114, 116, and 118 in mesh network 600. Also shown in FIG. 6 are different communication boundaries, including a direct communication range 623 and an indirect communication range 626. In this example, power tools 110, 112, and 114 are located outside of direct communication range 623 but inside of indirect communication range 626. Accordingly, these power tools are too far from wireless communication device 102 to communicate with wireless communication device 102 directly, but are located close enough to one or more of power tools 104, 106, 108, 116, and 118 inside of direct communication range 623 such that power tools 110, 112, and 114 can communicate with wireless communication device 102 indirectly via mesh network 600. Each of the nodes in mesh network 600 can execute logic according to process 1000 discussed in more detail below to dynamically determine an appropriate node type for operating within mesh network 600 for improved operational efficiency.

The nodes of mesh network 400 of FIG. 4 and 600 of FIG. 6 are illustrated as motorized power tools and non-motorized power tools (a jobsite light), and the nodes of mesh network 500 of FIG. 5 are illustrated as non-motorized power tools (jobsite lights). In some examples of mesh networks 400, 500, and/or 600 include exclusively motorized power tools, exclusively non-motorized power tools, or other combinations of motorized and non-motorized power tools such that one or more nodes in the mesh network are motorized (e.g., drill, saw, sander, etc.) and one or more nodes in the (same) mesh network are non-motorized power tools (e.g., a work light, a work radio, ruggedized tracking device, etc.) powered by a power tool battery (e.g., power tool battery pack 244) or other wireless communication-enabled devices. Power tool devices that can be used within mesh networks 400, 500, and 600 can include, for example, a battery charger (either plugged in, or not plugged in and powered by a coin cell or a battery such as a lithium-ion battery), a battery pack, a tool adapter, a tracking tag, a display (e.g., a dashboard), a router, and other types of power tool devices (e.g., include those described above with respect to power tools 104-118 and FIG. 1).

Wireless mesh networks may include several different node types that define the operation of a given node at a given time within the mesh network. A basic node type includes basic node functionality for receiving and processing broadcast, multicast, and unicast messages designated for the node as well as transmission of local mesh data. A relay node type includes basic node features in addition to mesh message relaying for range extension within the mesh network, including supporting multiple hops. A lower power node type limits power consumption for the node by waking up the node on specific time intervals to send messages or receive messages that are aggregated by a designated friend node. A friend node type includes message aggregation functionality for associated low power nodes during sleep cycles for the associated low power nodes and message delivery functionality for the associated low power nodes upon wake up. A friend node in a mesh network can generally have the physical property that it can aggregate messages in the mesh network. A proxy node type includes proxy functionality between devices that are not capable of communicating within the mesh network. For example, a smartphone may communicate through a proxy device that can connect a non-mesh device to the mesh network. Depending on the networking standard, different names and terminology can be used for similar types of nodes and/or different types of nodes can be used in accordance with different networking standards. For example, the Thread protocol refers to nodes types as a router node type, a sleepy end device node type, a parent node type, and others.

Power tool system 100 can be configured such that operation of a mesh network of power tools (e.g., mesh networks 400, 500, 600) follows an operation scheme to dynamically change mesh node types during the live operation of the wireless mesh network by distributed intelligence executing on individual nodes in the mesh network. This operation scheme can provide improved efficiency in terms of power consumption, data bandwidth, communication data rate, maximum number of connected nodes, maximum reachable distance, connection structure, and other aspects of mesh network operation. Each node in the mesh network can monitor a variety of variables including battery status (e.g., voltage, current health, etc.) of the node, the number of surrounding nodes, the status of the surrounding nodes, distances between nodes in the mesh network, number of hops in the mesh network, and other variables. Different node type decision criteria can be used including criteria related to data rate requirements (e.g., if an increased data rate is required between nodes for a limited duration, some node can transition to relay nodes), power consumption requirements (e.g., a node needs to operate longer from the same battery without an available replacement battery, the node can transition to a low power node), and distance requirements (e.g., a node looking to connect to the mesh network located at a far distance away, some nodes can transition to relay nodes).

Instructions 232, for example, can include or define one or more algorithms for determining a node type for power tool 104 during live operation within a mesh network such as mesh network 400, 500, or 600. The one or more algorithms can determine an appropriate node type for power tool 104 based on a variety of different factors, including operating parameters associated with power tool 104 and operating parameters associated with the mesh network including operating parameters associated with other power tools in the mesh network (e.g., any of power tools 106, 108, 110, 112, 114, 116, and 118). For example, when the state of a given node or the mesh network changes in a certain way, the one or more algorithms running on the given node can dynamically change the node type of the given node to adapt to the changed network environment. A variety of different node type transitions are possible for nodes operating in a mesh network, and some examples of node type transitions are discussed below. Within this disclosure one or more algorithms are described as performing certain functions, such as determining, transitioning or dynamically changing node types, detecting, evaluating, and the like. To implement such functions, the one or more algorithms (e.g., defined by the instructions 232), may be executed by a processor of a node implementing the one or more algorithms, such as the electronic processor 220. Accordingly, “one or more algorithms determining” may also be described as, for example: “a node determining, by executing one or more algorithms”; “a node determining”; or “a processor (of a node) determining.”

A node can be connected (provisioned) to a mesh network as a basic node and exchange data with other nodes in the mesh network. The battery voltage monitored by the one or more algorithms can decrease below a predetermined threshold. In response, the one or more algorithms can change the node type of the node from a basic node to a low power node.

A node can be connected (provisioned) to a mesh network as a basic node and exchange data with other nodes in the mesh network. The node can detect that a neighboring node has switched its type to operate as a low power node. Upon evaluation of the battery status for the node, the one or more algorithms can determine whether the node can change the node type to a friend node to aggregate messages for the neighboring low power node or not. If the battery level for the node is sufficient, the node can transition to a friend node for the neighboring low power node and also maintain operation as a basic node within the mesh network.

A node can be connected (provisioned) to a mesh network as a basic node and exchange data with other nodes in the mesh network. The node may have previously been operating using a battery as a power source, but has since been plugged into a charger. Upon connection to the charger, the one or more algorithms can determine that the node can transition to a relay node with the increased power budget resulting from the connection to the charger.

A node can be connected (provisioned) to a mesh network as a relay node and exchange data with other nodes in the mesh network. The node can be battery operated, and the one or more algorithms can determine that the battery voltage has dropped below a predetermined threshold. As a result, the node can transition from a relay node to a basic node.

A node can be connected (provisioned) to a mesh network as a relay node and exchange data with other nodes in the network. The one or more algorithms can detect the presence of multiple neighboring relay nodes within the mesh network and within a close distance (e.g., below a threshold distance). As a result, the node can transition to a basic node to conserve battery power. Due to the presence of the multiple surrounding relay nodes, the performance of the mesh network is not likely to be adversely affected by this transition.

A node can become a relay node when it is awake and being used by a user (e.g., a drill operated by a user to drill a hole). When the node is awake and being used by the user, the node can be powered by a main battery and the power consumption of the node can be inherently high (i.e., the primary function is to drive the motor which has high power operation). In this example, the wireless communication module on the node can be allowed to use more power because the node does not have to keep the targeted standby lifetime (e.g., 365 days with a 5 Ah battery without waking up the node).

A node can be connected (provisioned) to a mesh network as a basic node and exchange data with other nodes in the network. The one or more algorithms can detect that there is an insufficient amount of relay nodes operating within the mesh network (e.g., below a threshold), and therefore the data transmission efficiency between nodes may be insufficient. The node can transition to a relay node in order to forward messages to neighboring nodes and extend the communication range of the mesh network. In some cases, this transition may be further conditioned on the battery status of the node (e.g., the battery status indicating a battery voltage above a predetermined threshold).

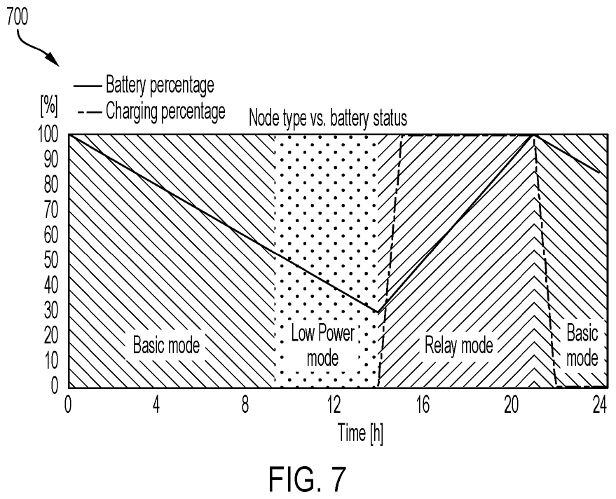

FIG. 7 shows an example graph 700 illustrating node type transition functionality in a power tool wireless mesh network, such as mesh network 400, 500, or 600. In graph 700, battery status (percent charged) for a given node (e.g., a node in mesh network 400, 500, or 600) is plotted on the y-axis, and time (hours) is plotted on the x-axis. Two different lines are plotted on the graph: one showing the battery status over time and one showing the charging status (based on connection to a charger) over time. The node type of the particular node, which the node has determined through processes and features described herein, is indicated in text in the shaded regions or areas of the graph 700. At time zero, the battery is fully charged (100%) and the node is not connected to a charger. For a period of about 9 hours, the node operates within the mesh network as a basic node and the battery status slowly deteriorates. Once the battery status drops below a threshold (50% charged in this example), the node dynamically changes its type to a low power node. While operating as a low power node, a charger is connected to the node, and the node dynamically changes its type to a relay node. After the charger is disconnected, and the battery status is above the threshold, the node dynamically changes its type back to a basic node. It is important to note that graph 700 is merely meant to provide an example of different node types and transition functionality, and should not be considered limiting. Other node types and/or transitions from different node types at different battery/charging percentages are used in some examples.

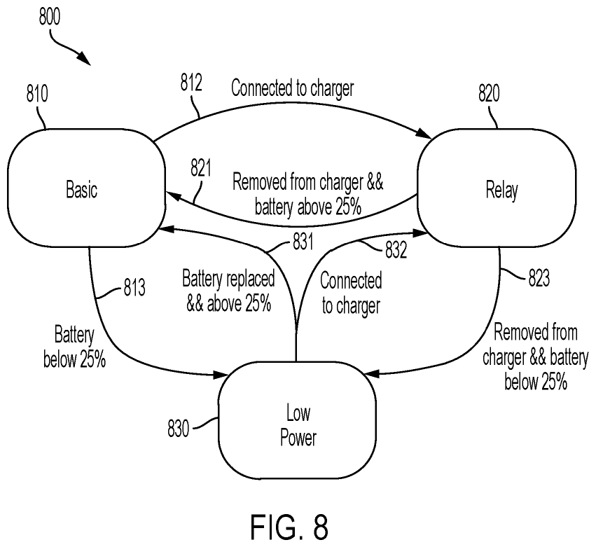

FIG. 8 shows an example state diagram 800 illustrating node type transition functionality implemented by a node (a power tool) in a power tool wireless mesh network, such as mesh network 400, 500, or 600. State diagram 800 includes three different states representing three different node types for a given node: a basic state 810, a relay state 820, and a low power state 830. The node can execute a transition 812 from basic state 810 to relay state 820 upon connection to a charger. The node can execute a transition 821 from relay state 820 to basic state 810 upon removal of a charger connection and a determination that the battery status is above a threshold charge level (25% charged in this example). The node can execute a transition 813 from basic state 810 to low power state 830 when the battery status drops below the threshold charge level. The node can execute a transition 831 between low power state 830 and basic state 810 when the battery is replaced, and the replacement battery status is above the threshold charge level. The node can execute a transition 823 from relay state 820 to low power state 830 when the node is removed from a charged and the battery status is below the threshold charge level. Finally, the node can execute a transition 832 from low power state 830 to relay state 820 upon connection to a charger.

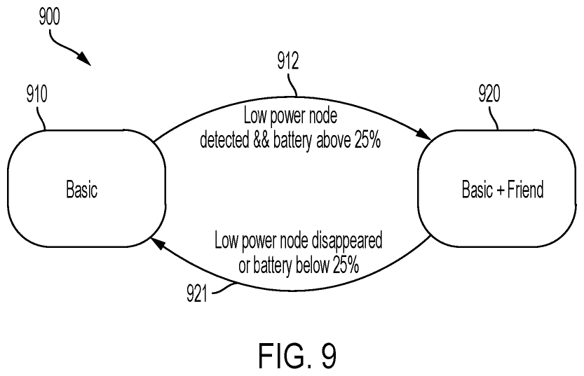

FIG. 9 shows another example state diagram 900 illustrating node type transition functionality implemented by a node (a power tool) in a power tool wireless mesh network, such as mesh network 400, 500, or 600. State diagram 900 includes two different states representing two different node types for a given node: a basic state 910 and a friend state 920. The node can execute a transition 912 from basic state 910 to friend state 920 upon detection of a neighboring low power node and a determination that the battery status of the node is above a threshold (25% charged in this example). The node can also execute a transition 921 upon a determination that a neighboring low power node has disappeared of a determination that the battery status of the node is below the threshold.

In some examples, each node in a power tool wireless mesh network (e.g., network 400, 500, or 600) implements node type transition functionality such as illustrated in the state diagram 800 of FIG. 8, the state diagram of FIG. 9, and/or a variation thereof.

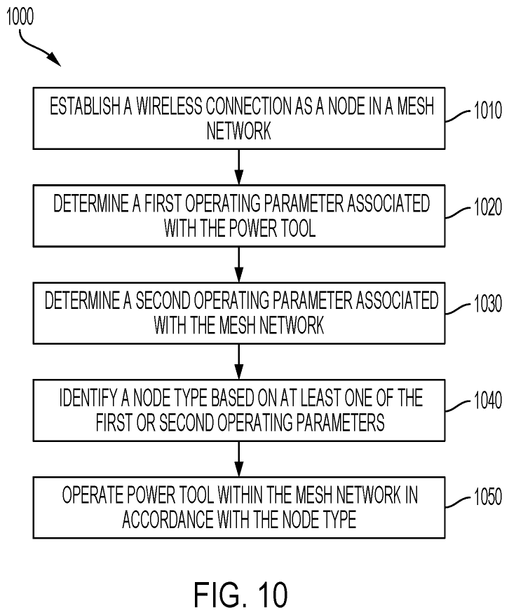

FIG. 10 shows a flowchart illustrating aspects of an example process 1000 for operating a power tool wireless mesh network, such as mesh network 400, 500, or 600. Process 1000 can be executed by a power tool operating as a node in a wireless mesh network, such as by any of 104, 106, 108, 110, 112, 114, 116, or 118 operating in mesh networks such as mesh network 400, 500, or 600. One or more algorithms for performing process 1000 can be stored in instructions 232 in memory 230, and executed by electronic processor 220, for example, where electronic controller 210 communicates within the mesh network using antenna 240. Various steps of process 1000, such as indicated at block 1020, 1030, and/or 1040, can in some implementations be conducted at least in part by server 122. Process 1000 can be used to provide improved efficiency in terms of power consumption, data bandwidth, communication data rate, maximum number of connected nodes, maximum reachable distance, connection structure, and other aspects of mesh network operation for power tool applications.

At block 1010, the node can establish a wireless connection as a node in a mesh network. For example, power tool 104 can establish a connection as a node within mesh network 400, 500, or 600 by communicating with wireless communication device 102, server 122, and/or power tools 106, 108, 110, 112, 114, 116, and/or 118 using antenna 240. The node can transmit data including a device identifier (e.g., a MAC address) and other information to establish a connection to the mesh network. Upon connection to the mesh network, the node can be configured to operate as a basic node if the battery status for the node is above a threshold or as a low power node if the battery status for the node is below a threshold.

At block 1020, the node can determine a first operating parameter associated with the power tool. For example, the first operating parameter can be a battery status for the power tool. The battery status can indicate voltage, current health, charge percentage, connection to one or more chargers, battery communication status, and other parameters associated with battery pack 244 and/or battery interface 242, for example. The node can determine that the battery percentage is above or below one or more thresholds, such as 25% charged or 50% charged. The node can also determine whether the battery is connected to a charger, whether a replacement battery has been installed, and other battery status information. The first operating parameter can also include data rate requirements for the node, distance of the node relative to one or more neighboring nodes (e.g., determined by the node based on signal strength or time of flight of communication signals), and other possible operating parameters for the node.

At block 1030, the node can determine a second operating parameter associated with the mesh network. The second operating parameter can be a variety of different parameters associated with the mesh network, including operating parameters associated with one or more neighboring nodes in the mesh network. For example, the second operating parameter can be a number of distinct surrounding nodes in the mesh network. The second operating parameter can also be a number of distinct surrounding nodes of a particular type in the mesh network (e.g., the number of nearby or total basic nodes, relay nodes, low powers, etc.). The second operating parameter can also be node type of a second power tool connected in the mesh network or a distance associated with the second power tool connected in the mesh network. The second operating parameter can also include data transmission requirements associated with the mesh network, and a variety of other aspects of the mesh network as a whole that are relevant with respect to node types. A node may determine a distance between itself and a neighbor node by determining a strength of signal or time of flight for communications to and/or from the neighbor node. Nodes in the mesh network can exchange individual node status information (e.g., battery status, number of connections) and/or general network-related status information or requirements (e.g., data rate or latency requirements) with each other. Accordingly, a particular node can receive, store, and maintain this information provided by other nodes in the network and, in block 1030, use or analyze the information to determine the second operating parameter.

A variety of different types of operating parameters can be used as the first operating parameter, the second operating parameter, and other operating parameters generally used in the automatic determination of node types for a mesh network. The battery status, for example, can include a battery type and/or voltage (e.g., 5.0 Ah lithium-ion, coin cell, solar energy, near-field communication (NFC) field, etc.). Also, network variables including speed of data transfer, received signal strength indicators (RSSI), number of hops of messages from a source to a destination, nearby nodes, quantity of traffic, noise levels, number and/or percentage of lost data packages or packets, type of traffic (e.g., status information, kickback alerts, tool locked alerts, trigger pull status updates, etc.) can be used as one or more of the operating parameters. Moreover, environmental variables such as time of day, location (e.g., in storage, in a toolbox, in a case, etc.) can be used can be used as one or more of the operating parameters, along with various types of settings including control application parameters and/or preferences, asset tracking and management settings (e.g., One-Key application settings), tool settings, and device settings.

At block 1040, the node can identify a node type based on at least one of the first operating parameter or the second operating parameter. That is, the node can identify the node type based on the first operating parameter, the second operating parameter, or both the first operating parameter and the second operating parameter. For example, the node can identify a low power node type based on the battery status of the node (e.g., below a threshold charge percentage and not connected to a charger). The node can also identify a basic node type based on the battery status of the node and/or the node types of one or more neighboring nodes in the mesh network. The node can also identify a relay node type based on the battery status of the node and/or the node types of one or more neighboring nodes in the mesh network. The node can also identify a friend node type basic node type based on the battery status of the node and/or the node types of one or more neighboring nodes in the mesh network. The node can generally implement a variety of different node type transitions at block 1040, such as discussed throughout the present disclosure (e.g., including with respect to the state diagrams of FIGS. 8 and 9 and the examples provided preceding the discussions of these state diagrams).

At block 1050, the node can operate within the mesh network in accordance with the node type. For example, the node can operate as a basic node and implement basic node functionality for receiving and processing broadcast, multicast, and unicast messages designated for the node and transmission of local mesh data. The node can also operate as a relay node and implement basic node features in addition to mesh message relaying for range extension within the mesh network, including supporting multiple hops. The node can also operate as a lower power node and limit power consumption by waking up on specific time intervals to send messages or receive messages aggregated by a friend node. The node can also operate as a friend node and aggregate messages for one or more neighboring low power nodes during sleep cycles for the one or more neighboring low power nodes and deliver message for the one or more low power nodes upon wake up of the one or more neighboring low power nodes. The node can also operate as a poxy node type and implement proxy functionality for devices that are not capable of communicating within the mesh network.

Wireless mesh networks of power tools can be used for a variety of purposes, and the dynamic node transition functionality discussed herein can enable and/or improve various aspects of power tool mesh network operation. A mesh network of power tools can be used to monitor the location of power tools on a jobsite and more precisely determine the exact location of power tools connected in a mesh network. By using a mesh network (e.g., an ad hoc mesh network), communication coverage of the network can be expanded, increasing the location tracking capabilities of the network. A mesh network of power tools can also be used to interface with safety equipment (e.g., fire protection, hazardous materials protection, etc.), security equipment (e.g., alarms, cameras, etc.), personal protective equipment, and the like for tracking and/or monitoring these components and for expanding the mesh network.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature can sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component (e.g., an electronic processor) can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions can be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A power tool comprising:
a power source;
an antenna for wireless communication; and
a controller in communication with the antenna and comprising an electronic processor and a memory, the electronic processor configured to execute instructions stored in the memory such that the controller is configured to:
establish a wireless connection as a node in a mesh network using the antenna;
determine a first operating parameter associated with the power tool;
determine a second operating parameter associated with the mesh network;
identify a node type of the power tool based on at least one of the first operating parameter or the second operating parameter; and
operate the power tool as the node in the mesh network in accordance with the node type.

2. The power tool of claim 1, wherein the power source comprises a battery and the first operating parameter comprises a status of the battery.

3. The power tool of claim 2, wherein the controller is configured to identify the node type as a basic node when the battery is removed from a charger and a charge level of the battery is above a threshold.

4. The power tool of claim 2, wherein the controller is configured to identify the node type as a low power node when a charge level of the battery is below a threshold.

5. The power tool of claim 2, wherein the controller is configured to identify the node type as a relay node when the battery is connected to a charger or when the power tool is being operated by a user.

6. The power tool of claim 1, wherein the second operating parameter comprises a number of surrounding nodes in the mesh network distinct from the node.

7. The power tool of claim 1, wherein the second operating parameter comprises a node type of a second power tool connected as a second node in the mesh network.

8. The power tool of claim 7, wherein the power source comprises a battery and the node type of the second node in the mesh network is a low power node, and wherein the controller is configured to identify the node type as a basic node when a charge level of the battery is below a threshold.

9. The power tool of claim 7, wherein the power source comprises a battery and the node type of the second node in the mesh network is a low power node, and wherein the controller is configured to identify the node type as a friend node when a charge level of the battery is above a threshold.

10. The power tool of claim 1, wherein the second operating parameter comprises a distance between the power tool and a second power tool connected as a second node in the mesh network.

11. A method for wireless power tool networking, the method comprising:
establishing, by a power tool, a wireless connection as a node in a mesh network;
determining, by the power tool, a first operating parameter associated with the power tool;
determining, by the power tool, a second operating parameter associated with the mesh network;
identifying, by the power tool, a node type of the power tool based on at least one of the first operating parameter or the second operating parameter; and
operating, by the power tool, as the node in the mesh network in accordance with the node type.

12. The method of claim 11, wherein determining the first operating parameter comprises determining a status of a battery that supplies power to the power tool, and wherein:
identifying the node type comprises identifying the node type as a basic node when the status of the battery indicates that the battery is removed from a charger and a charge level of the battery is above a threshold;
identifying the node type comprises identifying the node type as a low power node when the status of the battery indicates that the charge level of the battery is below the threshold; and
identifying the node type comprises identifying the node type as a relay node when the status of the battery indicates that the battery is connected to the charger.

13. The method of claim 11, wherein determining the second operating parameter comprises determining a node type of a second power tool connected as a second node in the mesh network, and wherein:
identifying the node type of the power tool comprises identifying the node type of the power tool as a basic node when the node type of the second power tool is a low power mode and a charge level of a battery that supplies power to the power tool is below a threshold; and
identifying the node type of the power tool comprises identifying the node type of the power tool as a friend node when the node type of the second power tool is a low power node and the charge level of the battery that supplies power to the power tool is above the threshold.

14. The method of claim 11, wherein determining the second operating parameter comprises determining a number of surrounding nodes in the mesh network distinct from the node.

15. The method of claim 11, wherein determining the second operating parameter comprises determining a distance between the power tool and a second power tool connected as a second node in the mesh network.

16. A power tool system comprising:
a first power tool wirelessly connected as a first node in a mesh network; and
a second power tool wirelessly connected as a second node in the mesh network, the second power tool comprising circuitry configured to:
determine a first operating parameter associated with the first power tool;
determine a second operating parameter associated with the second power tool;
identify a node type of the second power tool based on at least one of the first operating parameter or the second operating parameter; and
operate the second power tool as the second node in the mesh network in accordance with the node type.

17. The system of claim 16, wherein the first operating parameter comprises a distance between the first power tool and the second power tool.

18. The system of claim 16, wherein the first operating parameter comprises a number of power tools connected in the mesh network.

19. The system of claim 16, wherein the second operating parameter comprises a status of a battery that supplies power to the second power tool, and wherein the second power tool is configured to:
identify the node type as a basic node when the status of the battery indicates that the battery is removed from a charger and a charge level of the battery is above a threshold;
identify the node type as a low power node when the status of the battery indicates that the charge level of the battery is below the threshold; and
identify the node type as a relay node when the status of the battery indicates that the battery is connected to the charger.

20. The system of claim 16, wherein the first operating parameter comprises a node type of the first power tool, and wherein the second power tool is configured to:
identify the node type of the second power tool as a basic node when the node type of the first power tool is a low power mode and a charge level of a battery that supplies power to the second power tool is below a threshold; and
identify the node type of the second power tool as a friend node when the node type of the first power tool is a low power node and the charge level of the battery that supplies power to the second power tool is above the threshold.
